(19) United States
(12) Patent Application Publication
(10) Pub. No.: US 2026/0215625 A1
(43) Pub. Date: Jul. 30, 2026

(54) COFFEE BEAN GRINDING ASSEMBLY WITH TEMPERATURE CONTROL STRUCTURE

(71) Applicant: Guangdong Taineng Electric Appliance Manufacturing Co., Ltd., Dongguan (CN)

(72) Inventors: Jinqu CHEN, Dongguan (CN); Xiaotao YANG, Dongguan (CN); Junyan WU, Dongguan (CN)

(21) Appl. No.: 19/037,095

(22) Filed: Jan. 25, 2025

(51) Int. Cl. A47J 42/54; A47J 42/16; A47J 42/20; A47J 42/46

(52) U.S. Cl. CPC A47J 42/54; A47J 42/16; A47J 42/20; A47J 42/46; A47J 2202/00

(57) ABSTRACT

A coffee bean grinding assembly with a temperature control structure includes a frame including a cavity, a motor at a lower end of the frame, and a grinding tool assembly in the cavity, an output shaft of the motor is connected with a fixation bracket for a lower grinding tool, an upper end of the frame is provided with a fixation bracket for an upper grinding tool, a lower half of the grinding tool assembly is fixed on the fixation bracket for the lower grinding tool and rotates with a rotation thereof, a side of the fixation bracket for the upper grinding tool attached to the grinding tool assembly and/or a side of the frame is fixed with a temperature detection assembly, and the grinding tool assembly and/or the side of the frame and/or a bottom of the frame are provided with a plurality of heat dissipation assemblies.

### TECHNICAL FIELD

The present application relates to a technical field of coffee grinders, and, in particular, to a coffee bean grinding assembly with a temperature control structure.

### BACKGROUND ART

A semi-automatic coffee machine is a traditional Italian coffee machine. This kind of machines may carry out grinding, powder pressing, powder filling, brewing, and remove residue manually. This kind of machines is classified into a small domestic coffee machine with a single head, as well as a large commercial machine with dual or triple heads. A newer machine is further provided with an electronic water control mechanism, which may accurately and automatically control the water quantity to brew coffee. This kind of machines is mainly produced in Italy and is very popular there. It is mainly characterized in a simple machine structure, reliable operation, easy maintenance, by which high-quality Italian coffee may be made following a correct usage method. Disadvantages of this kind of machine constitute advantages at the same time, namely an operator needs to undergo strict training to make high-quality coffee using this kind of machines, and excellent baristas may provide customers with customized coffee.

The coffee grinders in the existing technology are all fixed by means of screws, which are installed in holes on a blade surface, and do not have the function of cooling the grinding tool, in case of long work of the grinding tool, the temperature thereof will rise and the overall grinding performance will decrease.

### SUMMARY

In order to overcome the shortcomings of the technology mentioned above, the present application provides a coffee bean grinding assembly with a temperature control structure, including a motor, a frame, and a grinding tool assembly, where the frame includes a cavity, a middle part of the cavity is through, the motor is installed at a lower end of the frame, an output shaft of the motor extends integrally or in sections to the cavity of the frame, the grinding tool assembly is arranged in the cavity, the output shaft is connected with a fixation bracket for a lower grinding tool, an upper end of the frame is provided with a fixation bracket for an upper grinding tool, the fixation bracket for the upper grinding tool is fixed on the frame through an upper cover, a lower half of the grinding tool assembly is fixedly installed on the fixation bracket for the lower grinding tool and configured to rotate with a rotation of the fixation bracket for the lower grinding tool, a side of the fixation bracket for the upper grinding tool attached to the grinding tool assembly and/or a side of the frame is fixed with a temperature detection assembly, and the grinding tool assembly and/or the side of the frame and/or a bottom of the frame are provided with a plurality of heat dissipation assemblies.

In one embodiment, the lower end of the frame is provided with a motor installation part, a convex installation part for the upper cover is provided at the upper end of the frame, the motor is installed on the motor installation part, the upper cover is installed on a first end of the convex installation part for the upper cover, and the fixation bracket for the upper grinding tool is installed between the upper cover and the upper end of the frame to limit an upper end of the grinding tool assembly after installation.

In one embodiment, the installation part for the upper cover is designed as a plurality of protruded plates arranged at intervals along a circumferential direction, the fixation bracket for the upper grinding tool is configured with a plurality of through grooves for the plurality of protruded plates to pass through, and ends of the plurality of protruded plates are fixedly connected to the upper cover after passing through the plurality of through grooves.

In one embodiment, the grinding tool assembly includes an upper grinding tool at the upper end of the grinding tool assembly and a lower grinding tool at a lower end of the grinding tool assembly, the upper grinding tool and the lower grinding tool each include a blade surface and an installation surface at two ends of the upper grinding tool and two ends of the lower grinding tool respectively, the blade surface of the upper grinding tool and the blade surface of the lower grinding tool are opposite to each other and overlap each other, the installation surface of the upper grinding tool is fixedly connected with the fixation bracket for the upper grinding tool, and the installation surface of the lower grinding tool is fixedly connected with the fixation bracket for the lower grinding tool.

In one embodiment, the installation surface of the upper grinding tool is fixedly connected with the fixation bracket for the upper grinding tool through fixing screws, and the installation surface of the lower grinding tool is fixedly connected with the fixation bracket for the lower grinding tool through fixing screws.

In one embodiment, the plurality of through grooves further include installation parts configured to install the plurality of heat dissipation assemblies, and the plurality of heat dissipation assemblies are installed on the installation surface of the upper grinding tool and extend into the installation parts of the plurality of heat dissipation assemblies.

In one embodiment, each of the plurality of heat dissipation assemblies includes heat dissipation fins and cooling fins, the cooling fins are sandwiched between the heat dissipation fins and the installation surface, and a side of the heat dissipation fins away from the installation surface is provided with a plurality of heat dissipation grilles.

In one embodiment, a front end of the output shaft is configured with a threaded blind hole, an installing hole is defined at an axis of the fixation bracket for the lower grinding tool, and after the output shaft passes through the installing hole, the threaded blind hole is in a threaded connection with the fixation bracket for the lower grinding tool to fix the fixation bracket for the lower grinding tool.

In one embodiment, the temperature detection assembly includes a NTC fixing nut and a NTC screw, and the NTC screw is fixed on the fixation bracket for the upper grinding tool through the NTC fixing nut.

In one embodiment, the output shaft has a non-circular cross-section, and the installing hole has a non-circular cross-section adapted to the output shaft.

In one embodiment, each of the plurality of heat dissipation assemblies includes heat dissipation aluminum fins and cooling fins, the heat dissipation aluminum fins are vertically provided on a circumferential side of the frame, and the cooling fins are vertically provided on a side of the frame facing the grinding tool assembly.

Optionally, each of the cooling fins is provided with a foam frame, and each of the cooling fins is arranged on the side of the frame through the foam frame.

In one embodiment, the heat dissipation aluminum fins are arranged on the circumferential side of the frame through a fixation bracket for the heat dissipation aluminum fin.

In one embodiment, the lower end of the frame is provided with a cooling fan.

In one embodiment, the cooling fan is fixed to the frame through a fixation bracket for the cooling fan.

In one embodiment, the temperature detection assembly is a NTC temperature sensor.

In one embodiment, the NTC temperature sensor is provided on a side of the frame facing the grinding tool assembly through a NTC fixing frame.

In one embodiment, the upper end of the frame is provided with an adjustable inner frame.

Compared with the existing technology, the coffee bean grinding assembly with a temperature control structure provided by the present application includes a motor, a frame, and a grinding tool assembly, the frame includes a cavity, a middle part of the cavity is through, the motor is installed at a lower end of the frame, an output shaft of the motor extends integrally or in sections to the cavity of the frame, the grinding tool assembly is arranged in the cavity, the output shaft is connected with a fixation bracket for a lower grinding tool, an upper end of the frame is provided with a fixation bracket for an upper grinding tool, the fixation bracket for the upper grinding tool is fixed on the frame through an upper cover, a lower half of the grinding tool assembly is fixedly installed on the fixation bracket for the lower grinding tool and configured to rotate with a rotation of the fixation bracket for the lower grinding tool, a side of the fixation bracket for the upper grinding tool attached to the grinding tool assembly and/or a side of the frame is fixed with a temperature detection assembly, and the grinding tool assembly and/or the side of the frame and/or a bottom of the frame are provided with a plurality of heat dissipation assemblies. The NTC temperature sensor is provided on a back of the upper grinding tool to detect the temperature of the grinding tool in real-time during operation, when the temperature of the grinding tool rises to a defined temperature during long-term operation, the cooling fins will start to work, so as to keep the grinding tool at a constant temperature during operation, thereby improving the long-term grinding performance of the product.

### BRIEF DESCRIPTION OF THE DRAWINGS.

FIG. 1 is an internal cross-sectional view of the present application.

FIG. 2 is an exploded view of the present application.

FIG. 3 is a cross-sectional view according to another embodiment of the present application.

FIG. 4 is an exploded view according to a further embodiment of the present application.

### DETAILED DESCRIPTION

In order to illustrate the present application more clearly, the present application will be further described in detail below in combination with the accompanying drawings.

The technical solution in the embodiments of the present application will be described more clearly and completely in conjunction with the accompanying drawings. It is conceivably that the described embodiments are only a part of the embodiments of the present application, not all of them. Based on the embodiments in the present application, all other embodiments obtained by those skilled in the art without creative labor are within the protection scope of the present application.

In the context of the present application, it should be understood that the orientation or positional relationships indicated by the terms “center”, “longitudinal”, “transverse”, “length”, “width”, “thickness”, “up”, “down”, “front”, “back”, “left”, “right”, “vertical”, “horizontal”, “top”, “bottom”, “inside”, “outside”, etc. are based on the orientation or positional relationships shown in the accompanying drawings, these terms are used merely for the convenience of describing the present application and for simplifying the description, but do not indicate or imply that the device or element referred to must have a specific orientation, be constructed and operated in the specific orientation, therefore, they should not be understood as a limitation on the present application. In addition, the terms “first” and “second” are only used for descriptive purposes and cannot be understood as indicating or implying relative importance or implying the quantity of technical features indicated. Thus, the features defined with “first” and “second” may explicitly or implicitly include one or more of these features. In the description of the present application, “a plurality of” means two or more, unless otherwise specifically emphasized.

In the present application, the term “example” is used to indicate “used as an example, illustration, or demonstration”. Any embodiments described as examples in the present application may not necessarily be interpreted as more preferred or advantageous than other embodiments. To enable those skilled in the art to implement and use the present application, the following description is provided. In the following description, details are listed for a purpose of explanation. It should be understood that those skilled in the art know that the present application can be implemented without using these specific details. In other embodiments, known structures and processes will not be elaborated in detail to avoid unnecessary details that make the description of the present application obscure. Therefore, the present application is not intended to be limited to the embodiments shown, but is consistent with the widest scope of principles disclosed in the present application.

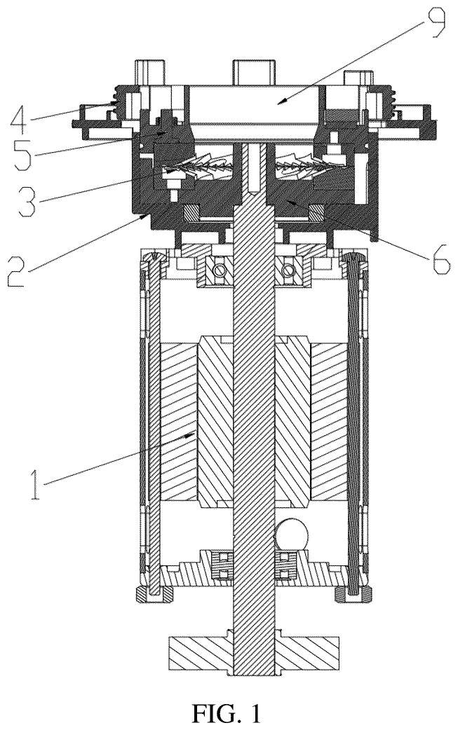

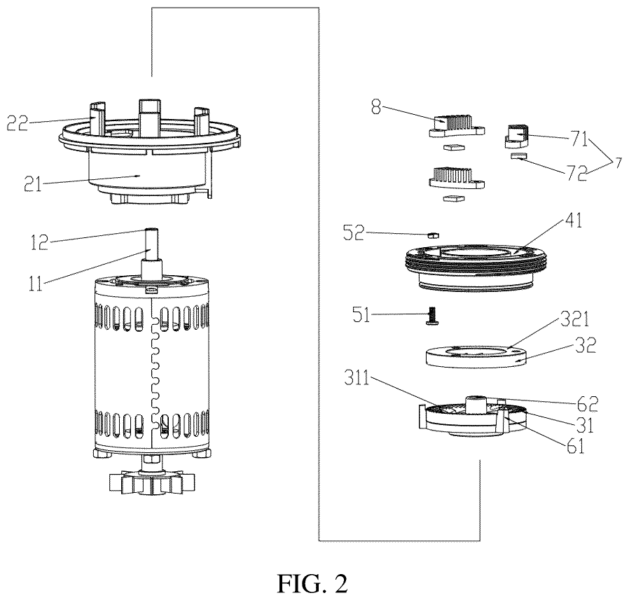

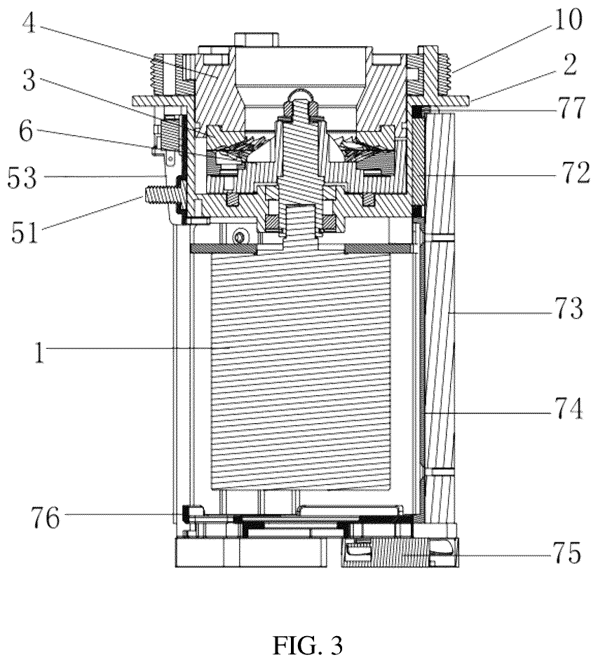

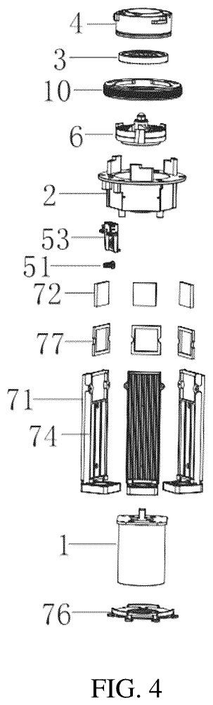

Referring to FIGS. 1-4, a coffee bean grinding assembly with a temperature control structure of the present application includes a motor 1, a frame 2, and a grinding tool assembly 3. The frame 2 includes an inner cavity that is hollow in a middle, the motor 1 is installed at a lower end of the frame 2, an output shaft 11 of the motor 1 extends into the inner cavity of the frame 2, and the grinding tool assembly 3 is provided in the inner cavity. The output shaft 11 is connected with a fixation bracket for a lower grinding tool 6, a fixation bracket for an upper grinding tool 4 is installed on an upper end of the frame 2, and the fixation bracket for the upper grinding tool 4 is fixed on the frame 2 through an upper cover. A lower half of the grinding tool assembly 3 is fixedly installed on the fixation bracket for the lower grinding tool 6 and rotates with the rotation of the fixation bracket for the lower grinding tool 6. The motor 1 drives the lower half of the grinding tool assembly 3 fixed on the fixation bracket for the lower grinding tool 6 to rotate by driving it to rotate. By fixing the frame 2 and the upper cover, an upper half of the grinding tool assembly 3 remains stationary, while the lower half of the grinding tool assembly 3 rotates to grind the coffee beans fed into the grinding tool assembly 3. Optionally, screw holes for installation are not defined on an internal blade surface 311 of the grinding tool assembly 3, but are defined on two end surfaces thereof away from the internal blade surface 311, which may ensure an integrity of the blade surface 311, so as to avoid hiding powder in a position where the locking screw is located which is difficult to clean, thereby improving an overall integrity, aesthetics, and uniformity of the coffee granules.

In one embodiment, the lower end of the frame 2 is provided with a motor installation part, and an upper end thereof is provided with a convex installation part for the upper cover 22, the motor 1 is installed on the motor installation part, and the upper cover is installed on an end of the installation part for the upper cover 22. The fixation bracket for the upper grinding tool 4 is installed between the upper cover and the upper end of the frame 2, which is configured to limit an upper end of the grinding tool assembly 3 after assembly. The frame 2 is configured to fix and assembly an entire coffee bean grinding assembly, the motor installation part at the lower end of the frame 2 is configured to fix and install the motor 1, and the installation part for the upper cover 22 at the upper end of the frame 2 is configured to fix the upper cover and to limit and fix the fixation bracket for the upper grinding tool 4 after being assembled with the upper cover. The fixation bracket for the upper grinding tool 4 and the fixation bracket for the lower grinding tool 6 work together to fix the grinding tool assembly 3 after fixation, thus completing a whole installation and fitting of the entire assembly with high integration.

Optionally, one side of the fixation bracket for the upper grinding tool 4 tightly attached to the grinding tool assembly 3 is fixed with a temperature detection assembly 5, and a plurality of heat dissipation assemblies 7 are provided on a top of the grinding tool assembly 3. The temperature detection assembly 5 is configured to detect a temperature value of the grinding tool assembly 3 in operation, so as to transmit temperature signals to a main control device, the main control device may control the operation of the plurality of heat dissipation assemblies 7 on the top of the grinding tool assembly 3 to dissipate heat according to transmitted temperature signals, thereby maintaining the work of the grinding tool assembly 3 at constant temperature and avoiding overheating that affects efficiency of grinding beans.

In one embodiment, the installation part for the upper cover 22 is designed as a plurality of protruded plates arranged at intervals along a circumferential direction, and the fixation bracket for the upper grinding tool 4 is configured with a plurality of through grooves 41 for the protruded plates to pass through. Ends of the protruded plates are fixedly connected with the upper cover after passing through the through grooves 41. The protruded plates pass through the fixation bracket for the upper grinding tool 4 and are fixedly connected with the upper cover, so as to fix the fixation bracket for the upper grinding tool 4, and the fixation bracket for the upper grinding tool 4 may fix the upper half of the grinding tool assembly 3.

Furthermore, the through grooves 41 include installation parts for installing the heat dissipation assemblies 7, the heat dissipation assemblies 7 are installed on an installation surface of the upper grinding tool and extend into the installation parts for installing the heat dissipation assemblies. The through grooves 41 may be used to dissipate the heat received by the heat dissipation assemblies 7 from the grinding tool assembly 3, more particularly, the heat dissipation assemblies 7 may be installed on the installation surface of the upper grinding tool through the through grooves 41 to make contact with the upper grinding tool, thereby absorbing and dissipating heat.

The heat dissipation assembly 7 includes heat dissipation fins 71 and cooling fins 72, the cooling fins 72 are sandwiched between the heat dissipation fins 71 and the installation surface. A side of the heat dissipation fins 71 away from the installation surface is provided with a plurality of heat dissipation grilles 8. After receiving a control signal from the main control device, the cooling fins 72 start to cooling to assist heat dissipation. The plurality of heat dissipation grilles 8 may enhance the heat dissipation effect.

In one embodiment, the grinding tool assembly 3 includes an upper grinding tool 32 at the upper end and a lower grinding tool 31 at the lower end, each of the upper grinding tool 32 and the lower grinding tool 31 includes a blade surface 311 and an installation surface 321 respectively at two ends, the blade surfaces 311 of the upper grinding tool 32 and the lower grinding tool 31 are opposite to each other and overlap each other, the installation surfaces 321 thereof are fixedly connected to the fixation bracket for the upper grinding tool 4 and the fixation bracket for the lower grinding tool 6, respectively, and the blade surfaces 311 opposite to each other may configured to grind coffee beans when rotating relative to each other.

In one embodiment, the installation surfaces 321 of the upper grinding tool 32 and the lower grinding tool 31 are fixedly connected to the fixation bracket for the upper grinding tool 4 and the fixation bracket for the lower grinding tool 6 respectively through fixing screws. The fixing screws are provided on a side away from the blade surfaces 311 to avoid making holes on the blade surfaces 311 and ensure the integrity of the blade surfaces 311.

In one embodiment, the fixation bracket for the lower grinding tool 6 further includes a plurality of stop pins on a side wall, the stop pins 61 are arranged at intervals, thereby clamping the lower grinding tool 31 during installation. The stop pins 61 is thus to limit the lower grinding tool 31 in a circumferential direction for fixation.

Optionally, the temperature detection assembly 5 is a NTC temperature sensor, including a NTC fixing nut 52 and a NTC screw 51. The NTC screw 51 is fixed to the fixation bracket for the upper grinding tool 4 through the NTC fixing nut 52, NTC (Negative Temperature Coefficient) refers to a negative temperature coefficient where a resistance decreases exponentially with increasing temperature. Material with NTC thermistor phenomenon is a semiconductor ceramic made by fully mixing, molding, sintering and other processes of two or more metal oxides such as manganese, copper, silicon, cobalt, iron, nickel, zinc, etc., which may be made into a thermistor with negative temperature coefficient (NTC). The resistivity and material constant thereof vary with different material composition ratios, sintering atmospheres, sintering temperatures, and structural states. Now there are also non oxide NTC thermistor materials represented by silicon carbide, tin selenide, tantalum nitride, etc.

In one embodiment, a front end of the output shaft 11 is configured with a threaded blind hole 12, an installing hole 62 is defined at an axis of the fixation bracket for the lower grinding tool 6. After the output shaft 11 passes through the installing hole 62, the threaded blind hole 12 is in a threaded connection with the fixation bracket for the lower grinding tool 6 to fix it. The output shaft 11 is connected to the installing hole 62 of the fixation bracket for a lower grinding tool 6 to fix the fixation bracket for the lower grinding tool 6, so that the fixation bracket for the lower grinding tool 6 rotates with a rotation of the output shaft 11.

In one embodiment, the output shaft 11 has a non-circular cross-section, and the installing hole 62 has a non-circular cross-section adapted to the output shaft 11. With a non-circular cross-section, relative rotation between the output shaft 11 and the installing hole 62 may be effectively prevented.

In one embodiment, in the middle of the grinding tool assembly, the fixation bracket for the upper grinding tool, and the upper cover each are configured with a throughhole for beans 9, and a plurality of throughholes for beans 9 constitute a coffee bean inlet.

In another embodiment, the heat dissipation assembly 7 includes heat dissipation aluminum fins 73 and cooling fins 72, the heat dissipation aluminum fins 73 are vertically provided on a circumferential side of the frame 2, and the cooling fins 72 are vertically provided on a side of the frame 2 facing the grinding tool assembly 3.

Optionally, the heat dissipation aluminum fins 73 are provided on the side of the frame 2 through a fixation bracket for the heat dissipation aluminum fin 74. The cooling fins 72 are provided with foam frames 77, and the cooling fins 72 are provided on the side of the frame 2 through the foam frames 77.

More particularly, the lower end of the frame 2 is provided with a cooling fan 7 The cooling fan 75 is fixed to the frame 2 through a fixation bracket for the cooling fan 76.

In one embodiment, the NTC temperature sensor is provided on the side of the frame 2 facing the grinding tool assembly 3 through a NTC fixation bracket 53.

In one embodiment, the upper end of the frame 2 is provided with an adjustable inner support 10.

An advantage of the present application lies in:

The NTC temperature sensor is installed on a back of the upper grinding tool to detect the temperature of the grinding tool in real-time during the operation, so that when the temperature of the grinding tool rises to a defined temperature during long-term operation, the cooling fins will start to cool, thereby keeping the grinding tool at a constant temperature in operation and improving the grinding performance for a long term.

The above disclosed embodiments are only a few specific embodiments of the present application, but the present application is not limited to them, any changes that can be considered by those skilled in the art should fall within a scope of protection of the present application.

What is claimed is:

1. A coffee bean grinding assembly with a temperature control structure, comprising a motor, a frame, and a grinding tool assembly, wherein the frame comprises a cavity, a middle part of the cavity extends through the frame, the motor is disposed at a lower end of the frame, an output shaft of the motor extends integrally or in sections to the cavity of the frame, the grinding tool assembly is arranged in the cavity, the output shaft is connected with a fixation bracket for a lower grinding tool, an upper end of the frame is provided with a fixation bracket for an upper grinding tool, the fixation bracket for the upper grinding tool is fixed on the frame through an upper cover, a lower half of the grinding tool assembly is fixedly disposed on the fixation bracket for the lower grinding tool and configured to rotate with a rotation of the fixation bracket for the lower grinding tool, at least one of a side of the fixation bracket for the upper grinding tool attached to the grinding tool assembly or a side of the frame is fixed with a temperature detection assembly, and at least one of the grinding tool assembly, the side of the frame, or a bottom of the frame is provided with a plurality of heat dissipation assemblies.

2. The coffee bean grinding assembly with the temperature control structure according to claim 1, wherein the lower end of the frame is provided with a motor installation part, a convex installation part for the upper cover is provided at the upper end of the frame, the motor is installed on the motor installation part, the upper cover is disposed on an end of the convex installation part for the upper cover, and the fixation bracket for the upper grinding tool is disposed between the upper cover and the upper end of the frame to limit movement of an upper end of the grinding tool assembly after installation.

3. The coffee bean grinding assembly with the temperature control structure according to claim 2, wherein the convex installation part for the upper cover is designed as a plurality of protruded plates arranged at intervals along a circumferential direction, the fixation bracket for the upper grinding tool is configured with a plurality of through grooves for the plurality of protruded plates to pass through, and ends of the plurality of protruded plates are fixedly connected to the upper cover after passing through the plurality of through grooves.

4. The coffee bean grinding assembly with the temperature control structure according to claim 3, wherein the grinding tool assembly comprises an upper grinding tool at the upper end of the grinding tool assembly and a lower grinding tool at a lower end of the grinding tool assembly, the upper grinding tool and the lower grinding tool each comprises a blade surface and an installation surface at two ends of the upper grinding tool and two ends of the grinding tool assembly respectively, the blade surface of the upper grinding tool and the blade surface of the lower grinding tool are opposite to each other and overlap each other, the installation surface of the upper grinding tool is fixedly connected with the fixation bracket for the upper grinding tool, and the installation surface of the lower grinding tool is fixedly connected with the fixation bracket for the lower grinding tool.

5. The coffee bean grinding assembly with the temperature control structure according to claim 4, wherein the installation surface of the upper grinding tool is fixedly connected with the fixation bracket for the upper grinding tool through fixing screws, and the installation surface of the lower grinding tool is fixedly connected with the fixation bracket for the lower grinding tool through fixing screws.

6. The coffee bean grinding assembly with the temperature control structure according to claim 4, wherein the plurality of through grooves comprise installation parts configured for installing the plurality of heat dissipation assemblies, and the plurality of heat dissipation assemblies are installed on the installation surface of the upper grinding tool and extend into the installation parts of the plurality of heat dissipation assemblies.

7. The coffee bean grinding assembly with the temperature control structure according to claim 1, wherein each of the plurality of heat dissipation assemblies comprises heat dissipation fins and cooling fins, the cooling fins are sandwiched between the heat dissipation fins and an installation surface, and a side of the heat dissipation fins away from the installation surface is provided with a plurality of heat dissipation grilles.

8. The coffee bean grinding assembly with the temperature control structure according to claim 1, wherein a front end of the output shaft is configured with a threaded blind hole, an installing hole is defined at an axis of the fixation bracket for the lower grinding tool, and after the output shaft passes through the installing hole, the threaded blind hole is in a threaded connection with the fixation bracket for the lower grinding tool to fix the fixation bracket for the lower grinding tool.

9. The coffee bean grinding assembly with the temperature control structure according to claim 1, wherein the temperature detection assembly comprises a negative temperature coefficient fixing nut and a negative temperature coefficient screw, and the negative temperature coefficient screw is fixed on the fixation bracket for the upper grinding tool or the frame through the negative temperature coefficient fixing nut.

10. The coffee bean grinding assembly with the temperature control structure according to claim 8, wherein the output shaft has a non-circular cross-section, and the installing hole has a non-circular cross-section adapted to the output shaft.

11. The coffee bean grinding assembly with the temperature control structure according to claim 1, wherein each of the plurality of heat dissipation assemblies comprises heat dissipation aluminum fins and cooling fins, the heat dissipation aluminum fins are vertically provided on a circumferential side of the frame, and the cooling fins are vertically provided on a side of the frame facing the grinding tool assembly.

12. The coffee bean grinding assembly with the temperature control structure according to claim 11, wherein each of the cooling fins is provided with a foam frame, and each of the cooling fins is arranged on the side of the frame facing the grinding tool assembly through the foam frame.

13. The coffee bean grinding assembly with the temperature control structure according to claim 11, wherein the heat dissipation aluminum fins are arranged on the circumferential side of the frame through a fixation bracket for each of the heat dissipation aluminum fins.

14. The coffee bean grinding assembly with the temperature control structure according to claim 1, wherein the lower end of the frame is provided with a cooling fan.

15. The coffee bean grinding assembly with the temperature control structure according to claim 14, wherein the cooling fan is fixed to the frame through a fixation bracket for the cooling fan.

16. The coffee bean grinding assembly with the temperature control structure according to claim 1, wherein the temperature detection assembly is a negative temperature coefficient temperature sensor.

17. The coffee bean grinding assembly with the temperature control structure according to claim 16, wherein the negative temperature coefficient temperature sensor is provided on a side of the frame facing the grinding tool assembly through a negative temperature coefficient fixing frame.

18. The coffee bean grinding assembly with the temperature control structure according to claim 1, wherein the upper end of the frame is provided with an adjustable inner frame.
